(19) United States
(12) Patent Application Publication
(10) Pub. No.: US 2020/0293988 A1
(43) Pub. Date: Sep. 17, 2020

(54) MOBILE DEVICE-BASED SYSTEMS AND METHODS FOR SELF-DIRECTED ASSIGNMENT OF FLEXIBLE DELIVERY WORK

(71) Applicant: COUPANG CORP., Seoul (KR)

(72) Inventors: Erik REHN, Seoul (KR); Yoo Suk KIM, Seoul (KR); Yul Hee LEE, Seoul (KR); Hye Leen CHOI, Seoul (KR); Han Jun LEE, Seoul (KR); Hyung Geun JI, Seoul (KR)

(21) Appl. No.: 16/299,742

(22) Filed: Mar. 12, 2019

(51) Int. Cl. G06Q 10/08; G06Q 10/06

(52) U.S. Cl. CPC G06Q 10/0835; G06Q 10/06311; G06Q 10/0834

(57) ABSTRACT

Disclosed embodiments provide systems and methods related to providing delivery offers for use with a user interface. A method for providing delivery offers comprises receiving, from a mobile device, a request for one or more delivery tasks including a geographical area and a time frame, accessing a database storing delivery tasks, each delivery task associated with a status of fully assigned, partially assigned, or not assigned based on a comparison of a number of workers assigned to the task and a number of workers necessary to complete the task, determining which of the stored delivery tasks needing assignment have a delivery route in the received geographical area and time frame, selecting one or more delivery offers if a status of each determined delivery offers is equal to partially assigned or not assigned, and responding to the received request by transmitting the one or more selected delivery offers to the mobile device.

### TECHNICAL FIELD

The present disclosure generally relates to computerized systems and methods for self-assignment of flexible delivery work. In particular, embodiments of the present disclosure relate to inventive and unconventional mobile systems enabling the use of mobile devices to select and receive delivery work assignments.

### BACKGROUND

Independent, flex, or occasional delivery workers spend a lot of time attempting to find delivery tasks suitable with their schedules and desired delivery areas. Current electronic systems for self-scheduling are inconvenient for these purposes, as the only tasks provided for selection may be those that lead a delivery worker to spend time making deliveries that are outside of their desired delivery area or available time to make deliveries.

In practice, electronically offering desirable delivery tasks to independent delivery workers is difficult because current electronic systems, which pursue the delivery company's interest in delivering more packages over the interests of delivery workers, often impose required delivery routes and packages upon delivery workers. While these systems attempt to do so in an efficient manner, many times the delivery workers will receive undesirable routes and packages they cannot deliver conveniently. Moreover, current electronic systems are inflexible in terms of requesting delivery tasks that are convenient to deliver. These disadvantages, moreover, cause delayed deliveries and inefficient travel.

Therefore, there is a need for improved methods and systems for self-assignment of flexible delivery work.

### SUMMARY

One aspect of the present disclosure is directed to a self-assignment method. The method may comprise operations. The operations comprise receiving, from a mobile device, a request for one or more delivery tasks, an available time frame for performing the one or more delivery tasks, and a geographical area for performing the one or more delivery tasks. The operations may further comprise accessing a database storing delivery tasks, each delivery task associated with a status of fully assigned, partially assigned, or not assigned. The status may be based on a comparison of a number of workers assigned to the task and a number of workers necessary to complete the task. The operations may further comprise determining which of the stored delivery tasks needing assignment have a delivery route in the received geographical area, determining one or more delivery offers by filtering the determined delivery tasks within the received available time frame, and selecting one or more delivery offers if a status of each determined delivery offers is equal to partially assigned or not assigned. The operations may further comprise responding to the received request by transmitting the one or more selected delivery offers to the mobile device.

Another aspect of the present disclosure is directed to a self-assignment system for providing delivery offers for use with a user interface. The self-assignment system may include one or more memory devices storing instructions. The self-assignment system may also include one or more processors configured to execute the instructions to perform operations as discussed above.

Yet another aspect of the present disclosure is directed to a system comprising the self-assignment system as discussed above, and a mobile device. Consistent with disclosed embodiments, the mobile device may include a network interface, one or more memory devices storing instructions, and one or more processors configured to execute the instructions to perform operations. The operations may include transmitting a request via the network interface for one or more delivery tasks, an available time frame for the one or more delivery tasks, and a geographical area for the one or more delivery tasks to a self-assignment system. The operations may further include receiving one or more delivery offers from the self-assignment system.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is an exemplary flow chart of process for providing delivery offers for use with a user interface from a self-assignment system to a mobile device, consistent with the disclosed embodiments.

FIG. 4A depicts an exemplary slide bar representation in a user interface of a mobile device for selecting an available time frame for performing delivery tasks, consistent with the disclosed embodiments.

FIG. 4B depicts an exemplary user interface of a mobile device for selecting at least one geographical area for performing delivery tasks, consistent with the disclosed embodiments.

FIG. 4C depicts an exemplary user interface of a mobile device after selecting an available time frame and at least one geographical area for performing delivery tasks, consistent with the disclosed embodiments.

FIG. 5 depicts an exemplary user interface of a mobile device displaying delivery offers, consistent with the disclosed embodiments.

FIG. 6 depicts an exemplary user interface of a mobile device displaying a precise delivery location on a map, consistent with the disclosed embodiments.

FIG. 7 depicts an exemplary user interface of a mobile device for filtering delivery offers by criteria, consistent with the disclosed embodiments.

FIG. 8 depicts an exemplary user interface of a mobile device for displaying a delivery schedule of a delivery worker, consistent with the disclosed embodiments.

FIG. 9 is an exemplary flow chart of process for cancelling an accepted delivery offer, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to a self-assignment system and method configured for providing delivery offers for use with a user interface. The disclosed embodiments provide innovative technical features that allow for automated delivery assignment based on a delivery request received in real-time. For example, the disclosed embodiments enable transmission of delivery offers to mobile devices in real-time upon request, enable delivery workers to request particular types of work while on the go or in a place where only mobile devices are usable, enable delivery workers to conveniently reject or cancel particular types of work, and enable delivery workers to conveniently select areas of interest for accepting delivery work.

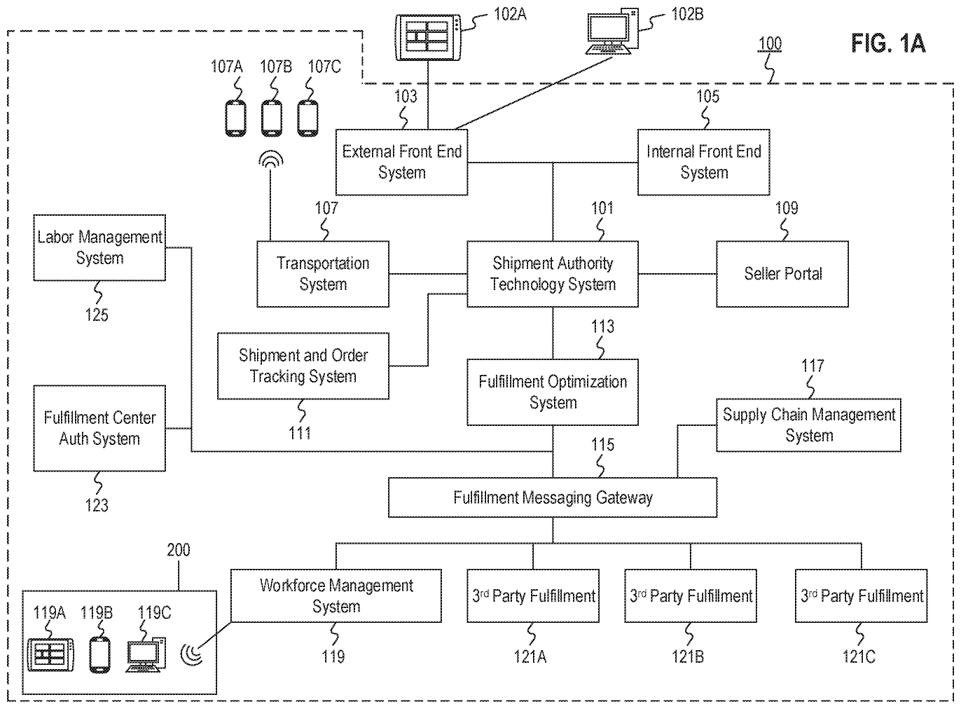

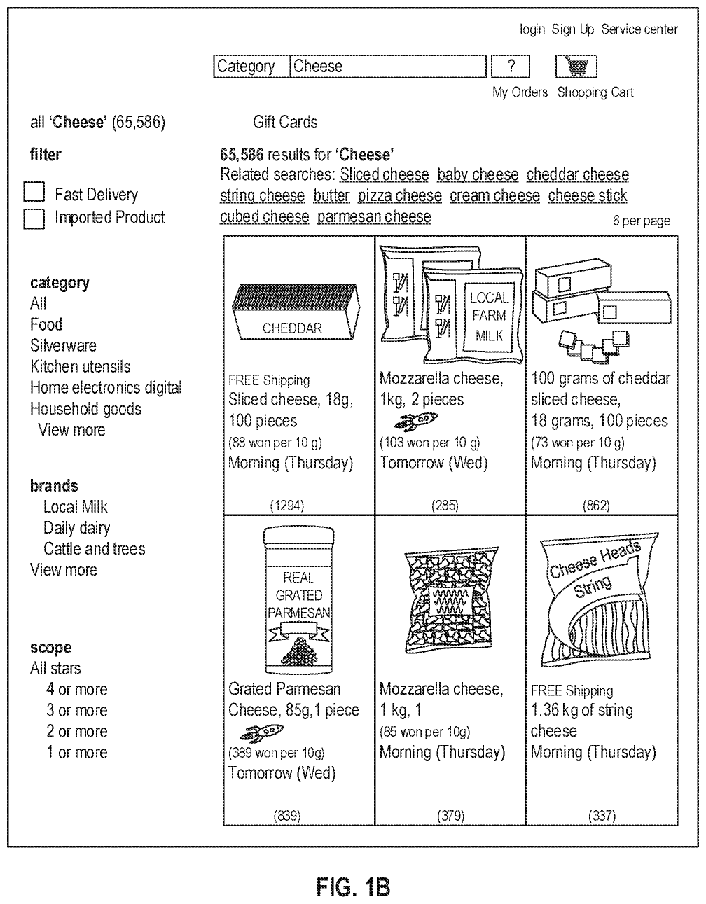

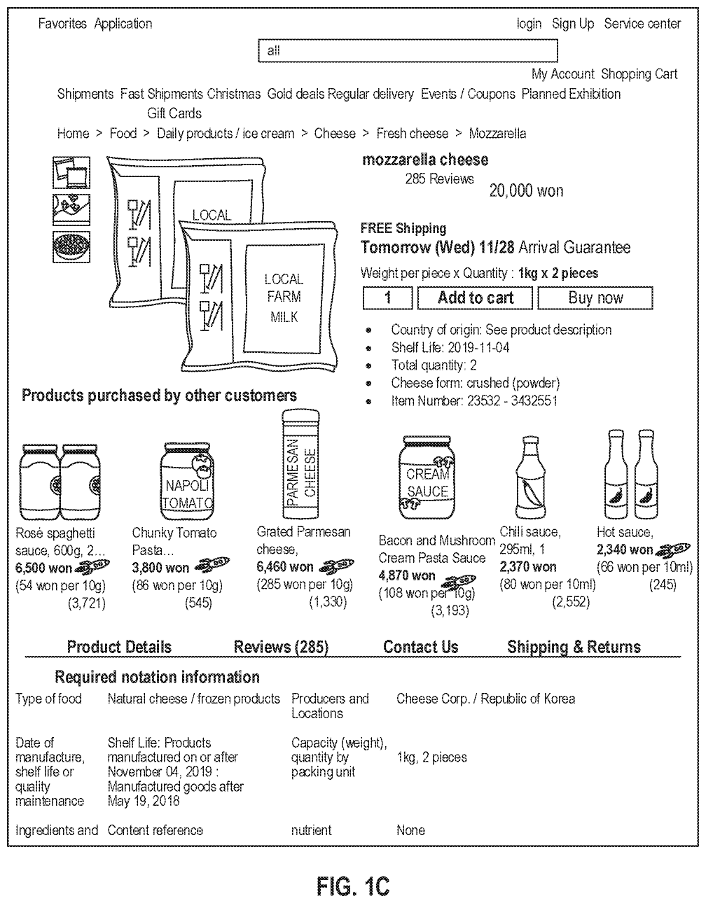

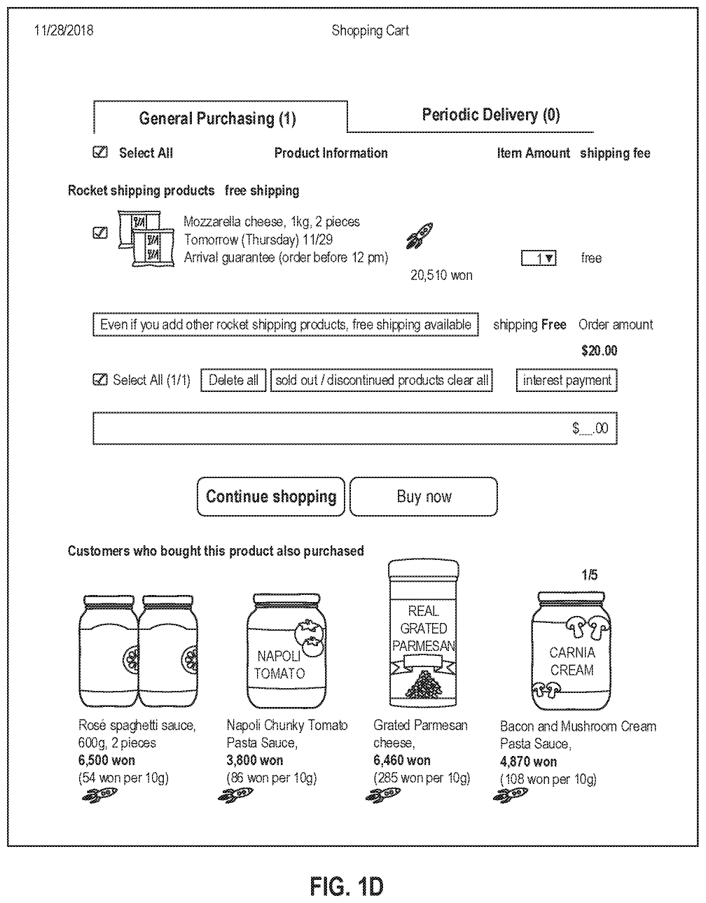

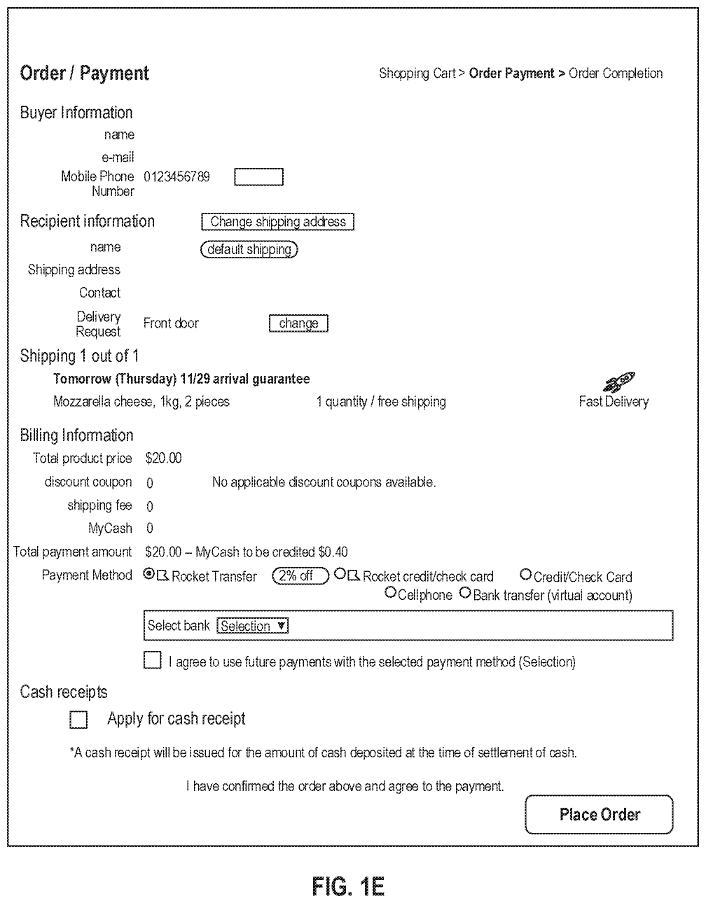

Referring to FIG. 1A, a schematic block diagram 100 illustrating an exemplary embodiment of a network comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, workforce management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in systems 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). Moreover, mobile devices 107A-C may execute applications and/or communication software that allows mobile devices 107A-C to communicate with Transportation system 107, and generates and displays content in interfaces via a display device included in mobile devices 107A-C. For example, mobile devices 107A-C may execute a mobile application to send a delivery related information to the Transportation system 107. In some embodiments, the delivery worker may capture photo(s) of the package and/or may obtain a signature using the mobile device. The mobile device may send a communication to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from workforce management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items that customers order may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in systems 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

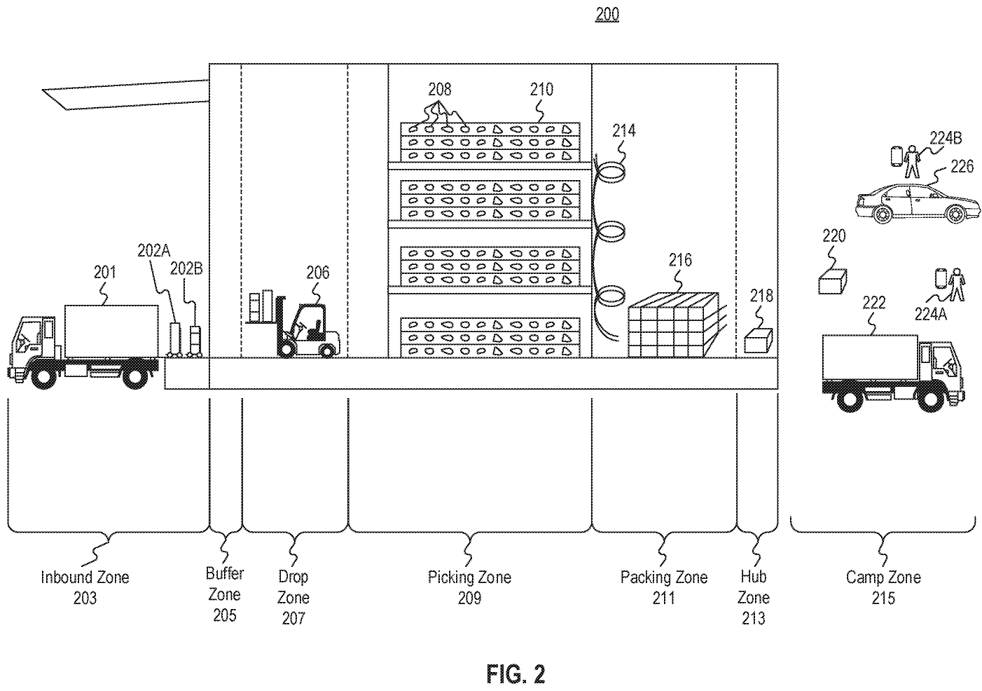

Workforce management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1 indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

According to an aspect of the present disclosure, self-assignment system for providing delivery offers for use with a user interface may comprise one or more memory devices storing instructions, and one or more processors configured to execute the instructions to perform operations. In some embodiments, the disclosed functionality and systems may be implemented as part of one or more of SAT system 101, transportation system 107, FO system 113, or WMS 119. The preferred embodiment comprises implementing the disclosed functionality and systems on transportation system 107, but one of ordinary skill will understand that other implementations are possible.

One or more memory devices may store data and instructions used to perform one or more features of the disclosed embodiments. For example, memory may represent a tangible and non-transitory computer-readable medium having stored therein computer programs, sets of instructions, code, or data to be executed by processor. Memory may include, for example, a removable memory chip (e.g., EPROM, RAM, ROM, DRAM, EEPROM, flash memory devices, or other volatile or non-volatile memory devices) or other removable storage units that allow instructions and data to be accessed by processor.

One or more memory devices may also include instructions that, when executed by processor, perform operations consistent with the functionalities disclosed herein. Devices consistent with disclosed embodiments are not limited to separate programs or computers configured to perform dedicated tasks. For example, memory may include one or more programs to perform one or more functions of the disclosed embodiments.

One or more processors may include one or more known processing devices, such as a microprocessor from the Pentium™ or Xeon™ family manufactured by InteI™, the Turion™ family manufactured by AMD™, the “Ax” or “Sx” family manufactured by Apple™, or any of various processors manufactured by Sun Microsystems. The disclosed embodiments are not limited to any type of processor(s).

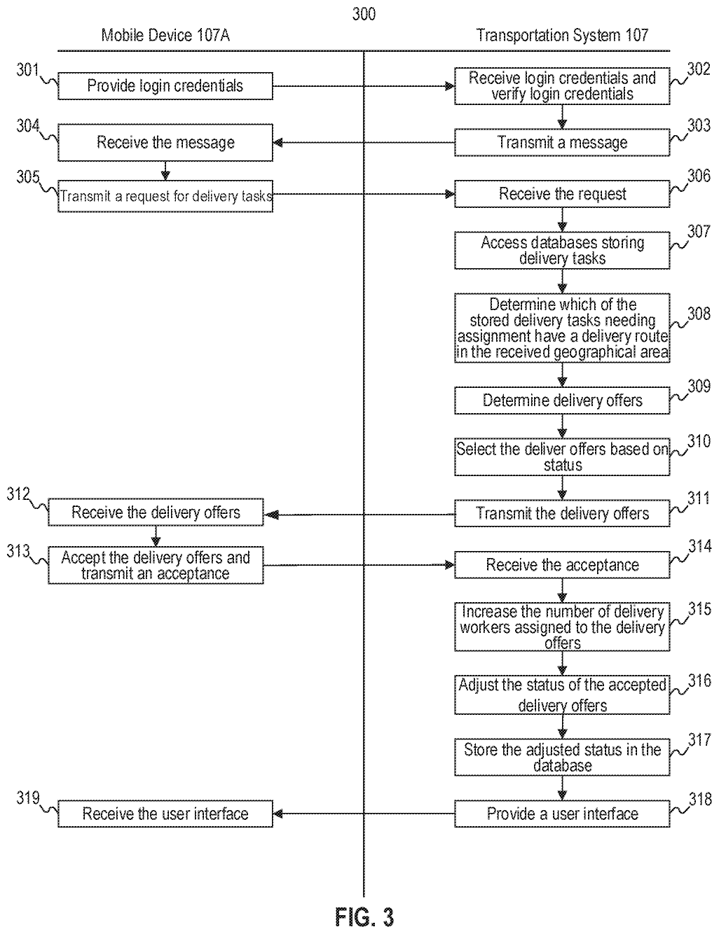

FIG. 3 is an exemplary flow chart of process 300 for providing delivery offers for use with a user interface from a self-assignment system to a mobile device 107A in FIG. 1A. As used herein, a user interface may be presented by a mobile application running on one of mobile devices 107A-C. While FIG. 3 is described with respect to mobile device 107A and transportation system 107, one of ordinary skill in the art will recognize that other configurations are possible.

In step 301, mobile device 107A of the delivery worker 224B may provide login credentials (e.g., received on a user interface) to transportation system 107. The login credential may include a User ID and password of the delivery worker 224B. For example, mobile device 107A may capture a user input for transmitting a User ID and password of the delivery worker 224B to the transportation system 107.

In step 302, transportation system 107 may receive and verify the login credentials. For example, transportation system 107 may receive login credentials (e.g., a User ID and password) from mobile device 107A and transmit it to WMS 119 for verification. As discussed above with respect to FIG. 1A, WMS 119 may store information associating one or more devices with one or more users associated with system 100.

In step 303, transportation system 107 may transmit a message including a result of the verification to the mobile device 107A in response to the verification from step 302. For example, transportation system 107 may transmit a message indicating a mobile device 107A of a delivery worker 224B is allowed to proceed with using features of a mobile application as login credentials were verified in step 302. Transportation system 107 may also transmit a message indicating a mobile device 107A of a delivery worker 224B is not allowed to proceed with using features of a mobile application as login credentials were not verified in step 302.

In step 304, mobile device 107A may receive the message. For example, transportation system 107 may provide, for presentation to the delivery worker 224B via the mobile device 107A, a user interface that includes message indicating login credentials were verified to proceed. In another example, a transportation system 107 may provide, for presentation to the delivery worker 224B via the mobile device 107A, a user interface that includes a message indicating invalid login credentials were received by the transportation system 107.

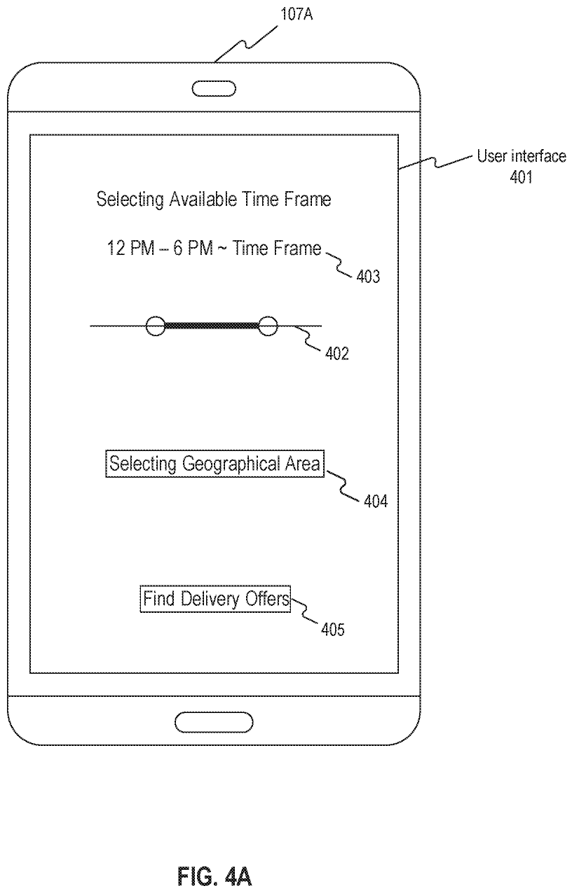

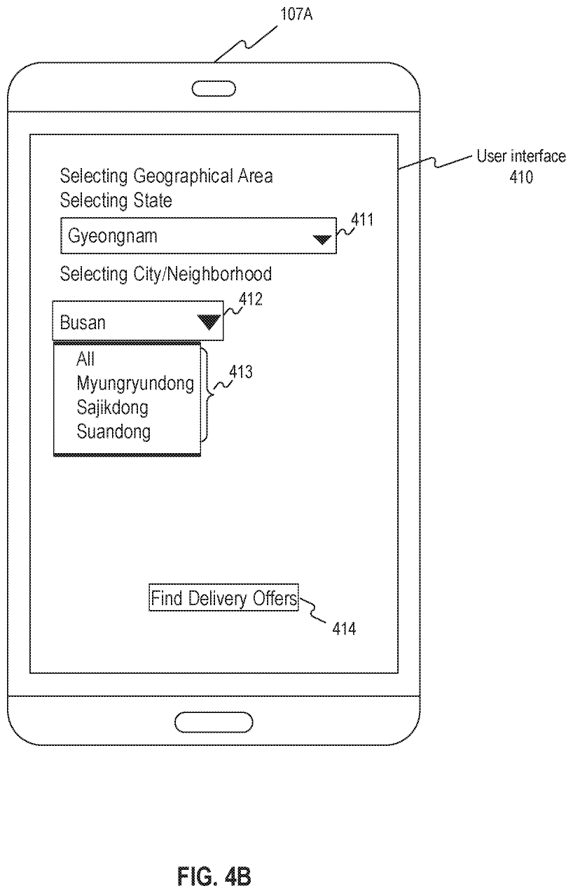

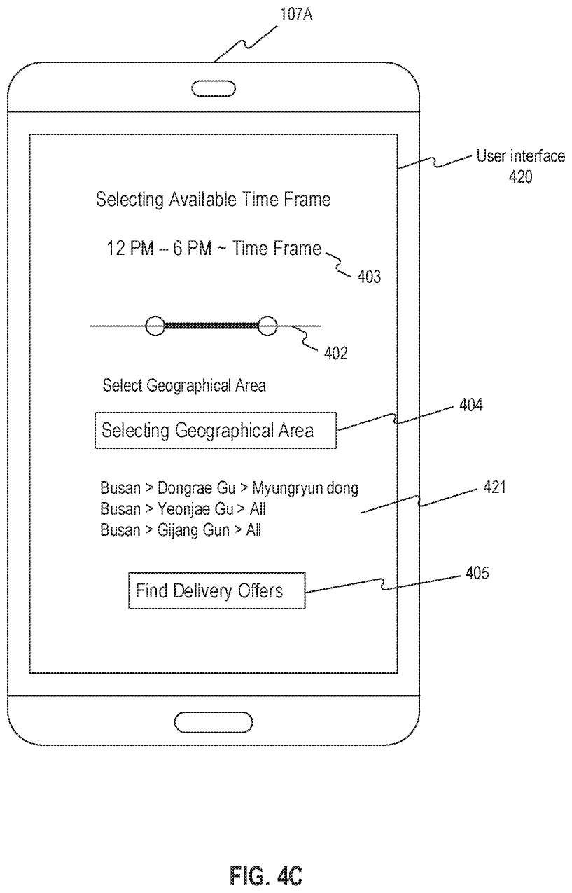

In step 305, if the login credentials were verified in step 303, mobile device 107A may transmit a request for one or more delivery tasks received from a user interface in mobile device 107A to transportation system 107. The request may comprise, for example, an available time frame and at least one geographical area for performing one or more delivery tasks received from a user interface to transportation system 107. For example, delivery worker 224B may configure a slide bar representation in a user interface of a mobile device 107A for configuring a time frame for performing one or more delivery tasks. By way of further example, a delivery worker 224B may specify at least one geographical area for performing delivery tasks by using a pressure-sensitive input mechanism (e.g., a touch-screen device) or any other appropriate selection mechanism on a user interface in a mobile device 107A. Exemplary user interfaces for requesting delivery tasks along with available time frame and geographical area for performing delivery tasks are illustrated in FIG. 4A and FIG. 4B and will be described in more detail. Other preferences are possible as well.

In step 306, transportation system 107 may receive the delivery request sent from step 305. The request may include, for example, a requested timeframe, a geographical area for performing one or more delivery tasks, or other preferences from the user.

In step 307, transportation system 107 may access a database (not pictured) storing delivery tasks as discussed above with respect to FIG. 1A. The database is described above as a database storing information from transportation system 107 for access by other systems in network 100.

In step 308, transportation system 107 may determine which of the stored delivery tasks needing assignment has a delivery route or sub-route in the received geographical area from step 306. For example, in some embodiments, transportation system 107 may send a request to FO system 113 for a location of closest FC 200 from the received geographical area. The FO system 113 may provide the location of closest FC 200 and transportation 107 may determine a particular delivery route or sub-route from FC 200, and match a delivery worker 224B to the delivery route or sub-route. Transportation system 107 may determine the delivery route or sub-route based on one or more of related package destinations for an efficiency of the delivery worker 224B.

In step 309, transportation system 107 may determine one or more delivery offers by filtering the determined delivery tasks from step 308 within the received available time frame from step 306. For example, transportation system 107 may determine one or more delivery offers based on a comparison of the received time frame from step 306 and the PPD assigned to each determined delivery tasks.

In step 310, transportation system 107 may select one or more of the filtered delivery offers based on a status of each determined delivery offers. In some embodiments, delivery offers may be selected in step 310 if the delivery offer is “not assigned” (e.g., if no workers are assigned to fulfill that delivery) or “partially assigned” (e.g., if fewer than a necessary number of workers are assigned to fulfill that delivery), and may not be selected if a status of each determined delivery offers is “fully assigned” (e.g., if the necessary number of workers are assigned to fulfill that delivery). For example, in some embodiments, a status of delivery offer may be “fully assigned” when a number of delivery workers assigned to the delivery offer is equal to a number of delivery workers required to complete the delivery offer. In other embodiments, a status of delivery offer may be partially assigned when a number of delivery workers assigned to the delivery offer is greater than zero but less than a number of delivery workers required to complete delivery offer. In another embodiments, a status of delivery offers may be not assigned when a number of delivery workers assigned to the offer equals to zero. As used herein, a delivery offer with fully assigned status may not be assigned to any delivery workers while a delivery offer with partially assigned or not assigned may be assigned to delivery workers.

In step 311, transportation system 107 may transmit the one or more selected delivery offers from step 310 to the mobile device 107A of the delivery worker 224B. For example, transportation system 107 may transmit a user interface providing selected delivery offers from step 310 to a mobile device 107A-C of a delivery worker 224B. In another example, a transportation system 107 may transmit a user interface to a mobile device 107A-C of a delivery worker 224B indicating no delivery offer is found based on the received information contained in the delivery request.

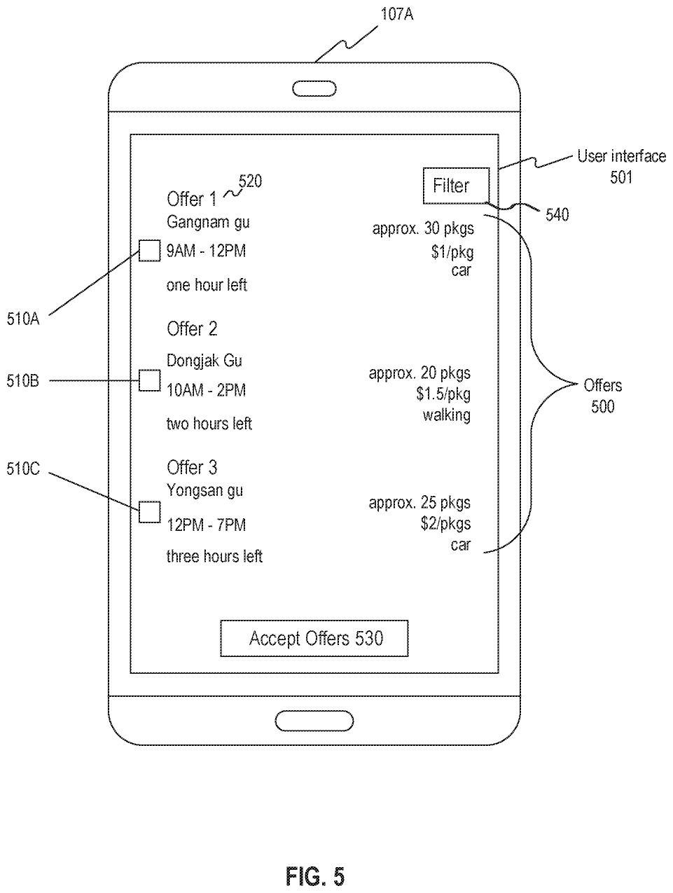

In step 312, mobile device 107A may receive the one or more transmitted delivery offers from the transportation system 107. For example, the mobile device 107A may present a user interface of the transmitted delivery offers including selectable interface elements respectively corresponding to the one or more determined delivery offers. Each of the displayed delivery offers may include one or more delivery locations, a number of packages, a time frame for the delivery, a time requirement for accepting the delivery offer, an amount of monetary compensation to be earned by the delivery worker per package delivered, a transportation method of each of the determined delivery offers, a location of each of the determined delivery offers on a map, or the like. In another example, a transportation system 107 may provide, for presentation to the delivery worker 224B via the mobile device 107A-C, a user interface that includes a message indicating no delivery offer is found. An example interface is discussed below with respect to FIG. 5.

In step 313, mobile device 107A of the delivery worker 224B may accept the received delivery offers from step 312 and transmit acceptance of the delivery offers by a user input on a user interface in the mobile device 107A to the transportation system 107. For example, a user interface in the mobile device 107A may present selectable user interface elements corresponding to each of the one or more delivery offers (e.g., check boxes). Mobile device 107A may transmit acceptance of the delivery offers by capturing input and transmitting the corresponding selected delivery offers to transportation system 107. An example interface is discussed below with respect to FIG. 5.

In step 314, transportation system 107 may receive acceptance of the delivery offers from mobile device 107A. For example, transportation system 107 may receive an acceptance, including a delivery related information, from a mobile application running on mobile device 107A.

In step 315, transportation system 107 may increase a number of delivery workers assigned to the accepted delivery offers by including the delivery worker 224B. For example, a number of delivery workers assigned to the delivery offer may change from two to three or zero to one.

In step 316, transportation system 107 may adjust a status of the accepted delivery offers. For example, in some embodiments, a status of the accepted delivery offers may update to fully assigned if the increased number of delivery workers assigned to the accepted delivery offers from step 315 is equal to the number of delivery workers required to complete delivery offer. In other embodiments, a status of the accepted offers may update to partially assigned if the increased number of delivery workers assigned to the accepted delivery offers from step 315 is less than the number of delivery workers required to complete delivery offer.

In step 317, transportation system 107 may store the adjusted status of the accepted delivery offers from 316 in the database (not pictured). For example, when a status of the accepted delivery offer changed from partially assigned to fully assigned, transportation system 107 may store the changed status in the database.

In step 318, transportation system 107 may provide data associated with a user interface to mobile device 107A. The data associated with the user interface may include an acceptance confirmation and a link to a communication channel for further communication between mobile device 107A and transportation system 107. For example, a communication channel link may include a communication channel with a social network service or chat service that provides instructions regarding package handling, delivery information, camp zone 215 information, instructions for communicating with a supervisor or a customer, or the like.

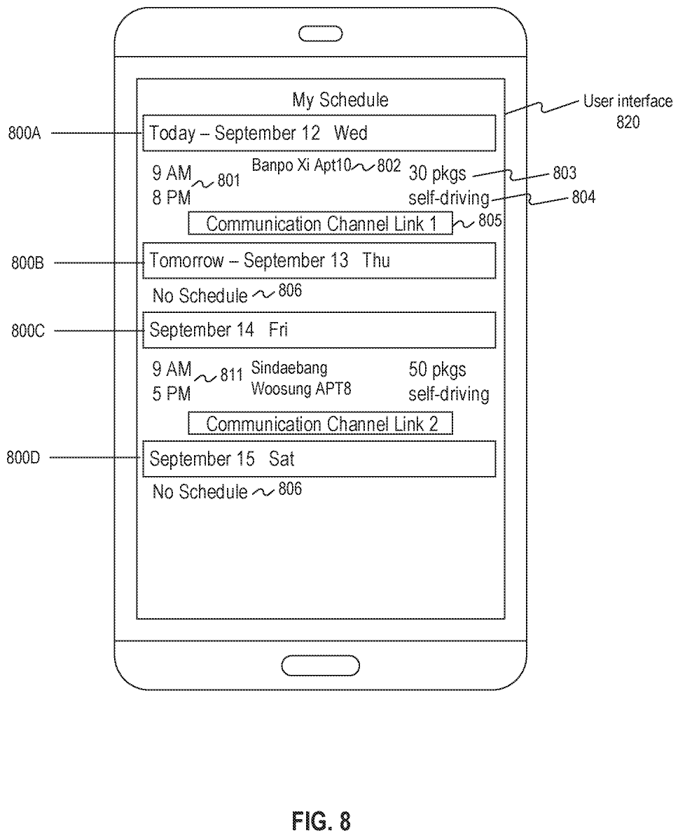

In step 319, mobile device 107A-C may receive data relating to a user interface from the transportation system 107. The data may include one or more acceptance confirmations and one or more communication channel links. Based on the received information, mobile device 107A may compose a delivery schedule listing each of a set of accepted offers comprising one or more dates, time requirements for delivery, delivery locations, number of packages, transportation methods of each delivery offer, or the like. The mobile device 107A may present the composed delivery schedule via a user interface. An example interface is discussed below with respect to FIG. 8.

FIG. 4A depicts an exemplary slide bar 402 in a user interface 401 on mobile device 107A for selecting an available time frame 402 for performing delivery tasks. For example, mobile device 107A may capture available time frame 403 based on a configuration of a slide bar representation 402 Slide bar 402 may be configured by a user's finger on a presence sensitive input mechanism (e.g., a touch-screen device). By way of further example, in some embodiments, in order to capture an available time frame for performing delivery tasks, delivery worker 224B may slide the circular portions of slide bar 402 to cover an available range of available delivery time frame. In exemplary FIG. 4A, the bolded portion of slide bar 402 represents an available time frame of 12 pm to 6 pm. Mobile device 107A may transmit the time frame selected using slide bar 402 to the transportation system 107 in step 305 of process 300 and further compared to a PPD of delivery tasks to determine one or more delivery offers in step 309.

User interface 401 may receive a press on button 404 to select at least one geographical area for performing delivery. In some embodiments, after receiving a press on button 404, the next interface shown on mobile device 107A may include another interface, such as the interface depicted in FIG. 4B.

User interface 401 may receive a press on button 405 to transmit a request for delivery works to transportation system 107 in step 305. In some embodiments, after receiving a press on button 405, the next interface shown on mobile device 107A may include another interface, such as the interface depicted in FIG. 5.

FIG. 4B depicts an exemplary user interface 410 of a mobile device 107A for selecting at least one geographical area for performing delivery tasks. For example, mobile device 107A may capture at least one geographical area based on a selection of state 411, city 412, and neighborhood 413. In some embodiments, mobile device 107A enables a user to select state 411, city 412, and neighborhood 413 using a pressure-sensitive input mechanism (e.g., a touch-screen device) or any other appropriate selection mechanism. By way of further example, after selecting a state 411, the available options for city 412 may be updated with associated respective information (e.g., cities inside of the selected state). Selecting a city 412 may cause the list of neighborhoods 413 to be updated in a similar fashion. A user (e.g., delivery worker 224B) may select one or more neighborhoods after selecting a city 412.

In some embodiments, after receiving a press on button 414, mobile device 107A may display another interface, such as the interface depicted in FIG. 4C.T

FIG. 4C depicts an exemplary user interface 420 of a mobile device 107A after selecting an available time frame 403 and at least one geographical area 421 for performing delivery tasks. User interface 420 may comprise information entered by a user in other user interfaces (e.g., user interface 401 in FIG. 4A). User interface 420 may also include list of neighborhoods selected for performing delivery 421 with respect to FIG. 4B. User interface 420, similar to user interface 401, may receive a press on button 405 to transmit a request for delivery works to transportation system 107. In some embodiments, after receiving a press on button 405, mobile device 107A may display another interface, such as the interface depicted in FIG. 5.

FIG. 5 depicts an exemplary user interface 501 of a mobile device 107A displaying delivery offers 500. Mobile device 107A may present user interface 501 to a user (e.g., delivery worker 224B), enabling the user to accept one or more of delivery offers 500. Each of delivery offers 520 may include a delivery location, a time frame for performing the delivery tasks, a time requirement for accepting the delivery offer, a number of packages, a package-based compensation value, a transportation method, or the like.

Delivery worker 224B may select one or more delivery offers 520 by actuating the selected offer (e.g., by pressing selectable interface elements on a screen on mobile device 107A, such as checkboxes, 510A, 510B, and 510C) corresponding to one or more delivery offers, to select desired offers. User interface 501 may then receive a press on button 530 to transmit selected delivery offers to the transportation system 107 in step 313.

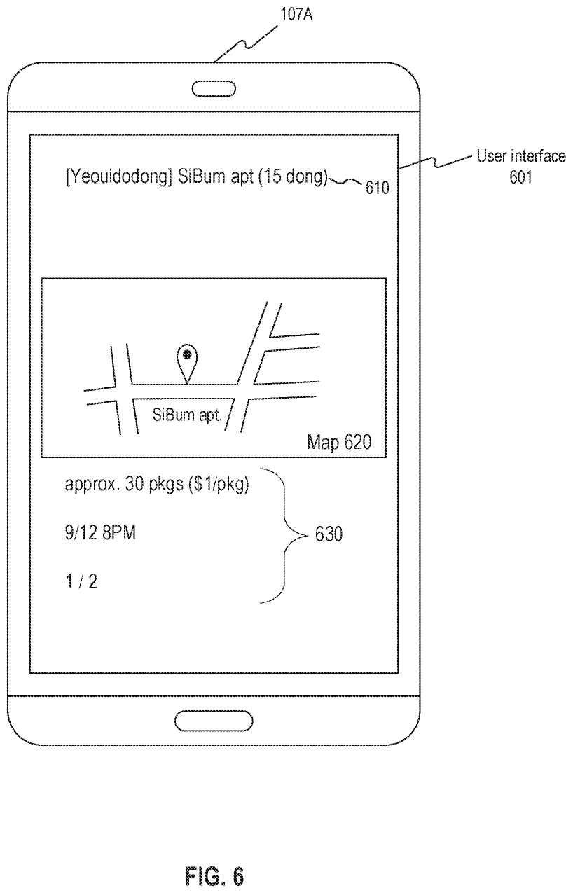

In some embodiments, user interface 501 may receive a press at delivery offer 520 to display details of the delivery offer. After receiving a press at delivery offer 520, the next interface shown on mobile device 107A may include another interface, such as the interface depicted in FIG. 6.

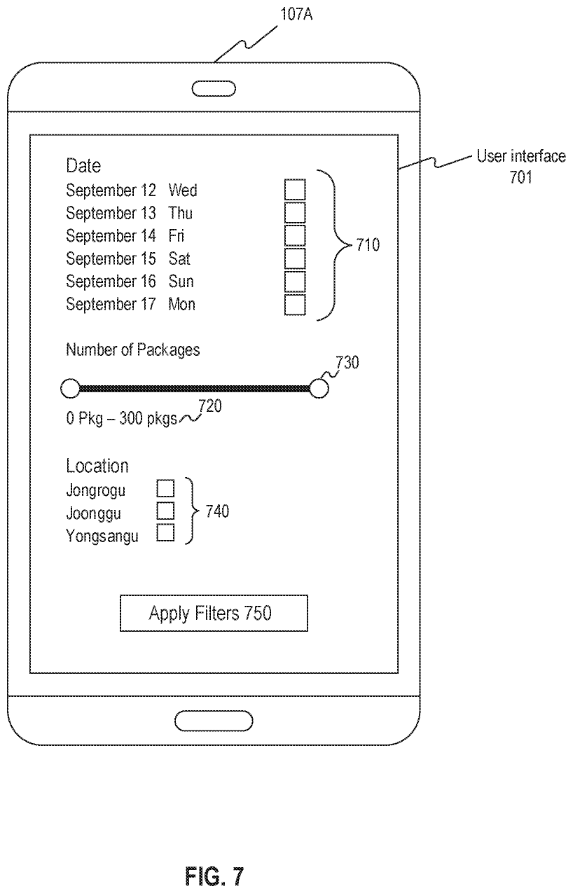

In another embodiments, user interface 501 may receive a press on button 540 to filter the received delivery offers 500. After receiving a press on button 540, mobile device 107A may display another interface, such as the interface depicted in FIG. 7.

FIG. 6 depicts an exemplary user interface 601 of a mobile device 107A displaying precise delivery location 610 on a map 620, and additional information 630. Precise location 610 on the map 620 may assist delivery worker 224B for delivering packages 220. A user may interact with user interface 601, and map 620 may zoom in or out based on such interactions (e.g., pinching or tapping on map 620).

User interface 601 may include additional information 630, including a number of packages and a package-based compensation value (e.g., how much a delivery worker will be compensated for delivering each package in the delivery offer), a time requirement for delivery or acceptance of the offer, and a listing of the number of delivery workers currently assigned to the delivery offer and a number of delivery workers required to complete delivery offer indicating whether a status of the delivery offer is partially assigned or not assigned. Other information may be presented on user interface 601 as well.

FIG. 7 depicts an exemplary user interface 701 of a mobile device 107A for filtering delivery offers by criteria 710, 720, and 740. Selectable interface elements 710 may refer to dates, a configurable element 720 may be configured by a slide bar 730 for a number of packages, and selectable interface elements 740 may refer to neighborhood for filtering the received delivery offers. For example, in some embodiments, a user (e.g., delivery worker 224B) may filter the received delivery offers by choosing one or more dates by selecting one or more selectable interface elements 710 corresponding to different dates. In some embodiments, delivery worker 224B may filter the received delivery offers by adjusting a slide bar 730 to choose number of packages. In some embodiments, delivery worker 224B may filter the received delivery offers by selecting one or more selectable interface elements 740 representing different neighborhoods. One or more embodiments may be executed simultaneously for filtering the delivery offers. By way of further example, user interface 701 may then receive a press on button 750 to filter the delivery offers with selected criteria. In some embodiments, after receiving a press on button 750, mobile device 107A may present the delivery offers accepted by the user but filtered based on elements 710, 720 or 740.

FIG. 8 depicts an exemplary user interface 820 of a mobile device 107A for displaying a delivery schedule of the delivery worker 224B. The mobile device 107A may compose the delivery schedule based on the confirmation of accepted delivery offers received from the transportation system 107 and present the user interface 820 including the schedule of delivery worker 224B via display. The schedule may include dates 800A-800D, a time frame for delivery 801, a delivery location 802, a number of packages 803, a method of delivery 804, a communication channel link 805, and a presentation of no schedule 806. Dates 800A-D may provide an indication to the delivery worker 224B on which date the delivery worker delivers packages. Time frame for delivery 801 may provide an indication to the delivery worker 224B an expected time for delivery. For example, time frame 801 represents a delivery window from 9 AM to 8 PM for the delivery on September 12, while time frame 811 represents a delivery window from 9 AM to 5 PM on September 14. Delivery location 802 may provide an indication to the delivery worker 224B where packages 220 must be delivered. A number of packages 803 may provide an indication to the delivery worker 224B how many boxes the delivery worker must deliver. A method of a delivery transportation 804 may refer to how the deliver worker should deliver the packages associated with the delivery.

A communication channel link 805 may refer to a social network service which may provide specific instructions to handle a particular package or a physical location of camp zone 215 to pick up delivery packages 220. Link 805, when pressed on by a user, may a user to a social network service to communicate with a supervisor, a customer, or a computer system as discussed above.

A presentation of no schedule 806 may provide an indication to the delivery worker 224B that the delivery worker may not have any deliveries on a particular date.

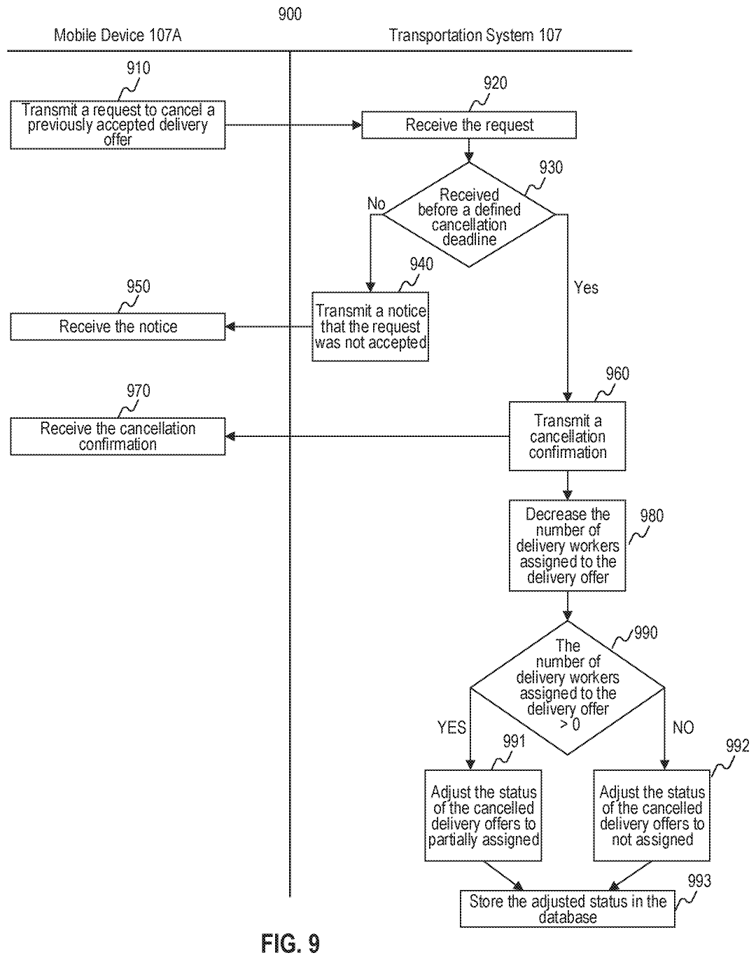

In an exemplary embodiment, transportation system 107 may include a feature that cancels one or more accepted delivery offers as requested from a mobile device 107A. FIG. 9 is an exemplary flow chart of process 900 for cancelling an accepted delivery offer.

In step 910, mobile device 107A may transmit a request to cancel a previously accepted delivery offer. For example, mobile device 107A may receive a cancellation request from a user input on a user interface and transmit the cancellation request including information of the accepted delivery offer to transportation system 107.

In step 920, transportation system 107 may receive the cancellation request. The cancellation request may reflect a delivery worker's 224B request for cancelling one or more delivery offers associated with delivery worker 224B.

In step 930, transportation system 107 may determine if the cancellation request was received before a defined cancellation deadline. If the cancellation request was not received before a define cancellation deadline, transportation system 107, in step 940, may transmit a message to the mobile device 107A indicating that the cancellation request was not accepted. If the request was received before a defined cancellation deadline, the transportation system 107, in step 960, may transmit a cancellation confirmation message to the mobile device 107A.

In step 940, as discussed above, transportation system 107 may transmit a message to the mobile device 107A indicating that the cancellation request was not accepted. The message may provide an indication to the delivery worker 224B that delivery worker 224B must perform the accepted delivery.

In step 950, the mobile device 107A may receive the message indicating that the cancellation request was not accepted from the transportation system 107. The message may be displayed on the mobile device 107A via a user interface. For example, a user interface, in the mobile device 107A, may display a message enclosing a rejected cancellation request on the mobile device 107A.

On the other hand, if in step 930 transportation system 107 determines that the received request was received before the cancellation deadline, process 900 may continue to step 960. In step 960, as discussed above, transportation system 107 may transmit a cancellation confirmation to the mobile device 107 indicating that the cancelation request was successful.

In step 970, mobile device 107A may receive the cancellation confirmation from the transportation system 107 indicating that the cancelation request was successful, and may display an appropriate message on a display screen.

In step 980, transportation system 107 may decrease the number of delivery workers assigned to the cancelled delivery offers. For example, transportation system 107 may change the assigned number of delivery workers from three to two or one to zero.

In step 990, transportation system 107 may determine if the decreased number of delivery workers assigned to the cancelled delivery offers in step 980 is greater than zero. If the decreased number of delivery workers assigned to the cancelled delivery offers is greater than zero, the transportation system 107, in step 991, may adjust the status of the cancelled delivery offers to “partially assigned.” If the decreased number of delivery workers assigned to the cancelled delivery offers is not greater than zero, the transportation system 107, in step 992, may adjust the status of the cancelled delivery offers to “not assigned.”

In step 993, transportation system 107 may store the adjusted status of the cancelled delivery offers in a database. For example, when a status of the cancelled delivery offers changed from partially assigned to not assigned, transportation system 107 may store the changed status in the database.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A self-assignment system for providing delivery offers for use with a user interface, comprising:
one or more memory devices storing instructions; and
one or more processors configured to execute the instructions to perform operations comprising:
receiving, from a first mobile device and in response to at least one selection made on a user interface element of the first mobile device, a first request for one or more delivery tasks, an available time frame for performing the one or more delivery tasks, and a geographical area for performing the one or more delivery tasks;
accessing a first database storing delivery tasks;
determining which of the stored delivery tasks needing assignment have a delivery route in the received geographical area;
determining one or more delivery offers by filtering the determined delivery tasks within the received available time frame, each delivery offer associated with a status of fully assigned, partially assigned, or not assigned, the status being based on a comparison of:
a number of workers assigned to the task, and
a number of workers necessary to complete the task;
selecting, from among the determined delivery offers, one or more delivery offers having a status equal to partially assigned or not assigned;
responding to the received first request by transmitting the one or more selected delivery offers to the first mobile device;
receiving, from the first mobile device, an acceptance of at least one of the transmitted delivery offers;
based on the received acceptance, adjusting the status of the at least one accepted delivery offer;
providing, for presentation via the first mobile device, a user interface that includes a confirmation of the at least one accepted delivery offer and a link to a communication channel for communication between the first mobile device and a remote device;
storing the adjusted status of the accepted delivery offer in a second database;
receiving a second request for one or more delivery tasks from a second mobile device; and
responding to the received second request by transmitting one or more selected delivery offers based on the adjusted status.

2. The self-assignment system of claim 1, wherein at least one of the selected delivery offers includes one or more delivery tasks to one or more neighborhoods based on a selection of a city.

3. The self-assignment system of claim 1, wherein the operations further comprise receiving from the first mobile device the available time frame for performing the delivery tasks as a slide bar representation in a user interface of the first mobile device.

4. The self-assignment system of claim 1, wherein the operations further comprise providing, for presentation via the first mobile device, a user interface that includes selectable interface elements respectively corresponding to the one or more determined delivery offers, each of the determined delivery offers including one or more delivery locations, a number of packages, a time frame for the delivery, a time requirement for accepting the delivery offer, an amount of monetary compensation to be earned per package delivered, a transportation method of each of the determined delivery offers, or a location of each of the determined delivery offers on a map.

5. The self-assignment system of claim 1, wherein the operations further comprise:
providing, for presentation via the first mobile device, a first user interface that includes selectable interface elements for filtering delivery offers by criteria including one or more of a date for performing the delivery, a number of packages, or one or more locations associated with each delivery offer; and
in response to selection of one of the selectable interface elements for filtering via the user interface of the first mobile device, providing, for presentation to the user via the first mobile device, a second user interface that includes one or more of the filtered delivery offers.

6. The self-assignment system of claim 1, wherein the operations further comprise receiving login credentials from the first mobile device and verifying the login credentials before proceeding to process the first request.

7. The self-assignment system of claim 1, wherein the operations further comprise:
receiving, from the first mobile device, acceptance of one or more of the transmitted delivery offers; and
marking each accepted offer as fully assigned or partially assigned in the database.

8. The self-assignment system of claim 7, wherein the operations further comprise:
receiving a request to cancel one or more previously accepted delivery offers from the first mobile device;
responding to the received request by transmitting a cancellation confirmation to the first mobile device when the request is received before a defined cancellation deadline;
decreasing the number of delivery workers assigned to the cancelled delivery offers;
adjusting the status of the cancelled delivery offers to partially assigned or not assigned based on the number of delivery workers assigned to the cancelled delivery offers; and
storing the adjusted status of the cancelled delivery offers in the database.

9. The self-assignment system of claim 7, wherein marking each accepted offer further comprises:
increasing the number of delivery workers assigned to the accepted delivery offers;
adjusting the status of the accepted delivery offers to fully assigned or partially assigned based on the number of delivery workers assigned to the delivery offer; and
storing the adjusted status of the accepted delivery offers in the database.

10. A computer-implemented self-assignment method for providing delivery offers for use with a user interface, comprising:
receiving, from a first mobile device and in response to at least one selection made on a user interface element of the first mobile device, a first request for one or more delivery tasks, an available time frame for performing the one or more delivery tasks, and a geographical area for performing the one or more delivery tasks;
accessing a first database storing delivery tasks;
determining which of the stored delivery tasks, from the database, needing assignment have a delivery route in the received geographical area;
determining one or more delivery offers by filtering the determined delivery tasks within the received available time frame, each delivery offer associated with a status of fully assigned, partially assigned, or not assigned, the status being based on a comparison of:
a number of workers assigned to the task, and
a number of workers necessary to complete the task;
selecting, from among the determined delivery offers, one or more delivery offers having a status equal to partially assigned or not assigned;
responding to the received first request by transmitting one or more of the selected delivery offers to the first mobile device;
receiving, from the first mobile device, an acceptance of at least one of the transmitted delivery offers;
based on the received acceptance, adjusting the status of the at least one accepted delivery offer;
providing, for presentation via the first mobile device, a user interface that includes a confirmation of the at least one accepted delivery offer and a link to a communication channel for communication between the first mobile device and a remote device;
storing the adjusted status of the accepted delivery offer in a second database;
receiving a second request for one or more delivery tasks from a second mobile device; and
responding to the received second request by transmitting one or more selected delivery offers based on the adjusted status.

11. The method of claim 10, wherein at least one of the selected delivery offers includes one or more delivery tasks to one or more neighborhoods based on a selection of a city.

12. The method of claim 10, further comprising receiving from the first mobile device the available time frame for performing delivery tasks as a slide bar representation in a user interface of the first mobile device.

13. The method of claim 10, further comprising providing, for presentation via the first mobile device, a user interface that includes selectable interface elements respectively corresponding to the one or more determined delivery offers, each of the determined delivery offers including one or more delivery locations, a number of packages, a time frame for the delivery, a time requirement for accepting the delivery offer, an amount of monetary compensation to be earned per package delivered, a transportation method of each of the determined delivery offers, or a location of each of the determined delivery offers on a map.

14. The method of claim 10, further comprising:
providing, for presentation via the first mobile device, a first user interface that includes selectable interface elements for filtering delivery offers by criteria including one or more of a date for performing the delivery, a number of packages, or one or more locations associated with each delivery offer; and
in response to selection of one of the selectable interface elements for filtering via the user interface of the first mobile device, providing, for presentation to the user via the first mobile device, a second user interface that includes one or more of the filtered delivery offers.

15. The method of claim 10, further comprising receiving login credentials from the first mobile device and verifying the login credentials before proceeding to process the first request.

16. The method of claim 10, further comprising:
receiving from the first mobile device, acceptance of one or more of the transmitted delivery offers;
marking each accepted offer as fully assigned or partially assigned in the database.

17. The method of claim 16, further comprising:
receiving a request to cancel one or more previously accepted delivery offers from the first mobile device;
responding to the received request by transmitting a cancellation confirmation to the first mobile device when the request is received before a defined cancellation deadline;
decreasing the number of delivery workers assigned to the cancelled delivery offers;
adjusting the status of the cancelled delivery offers to partially assigned, if the decreased number of delivery workers assigned to the cancelled delivery offers is greater than zero, or not assigned, if the decreased number of delivery workers assigned to the cancelled delivery offers is equal to zero; and
storing the adjusted status of the cancelled delivery offers in the database.

18. The method of claim 16, wherein the marking offers further comprise:
increasing the number of delivery workers assigned to the accepted delivery offers;
adjusting the status of the accepted delivery offers to fully assigned, if the increased number of delivery workers assigned to the accepted delivery offers is equal to the number of delivery workers required to complete delivery offer, or partially assigned, if the increased number of delivery workers assigned to the accepted offers is less than the number of delivery workers required to complete delivery offer; and
storing the adjusted status of the accepted delivery offers in the database.

19. A system comprising:
a first mobile device comprising:
a network interface;
one or more memory devices storing instructions; and
one or more processors configured to execute the instructions to perform operations comprising:
transmitting, via the network, a first request for one or more delivery tasks, an available time frame for the one or more delivery tasks, and a geographical area for the one or more delivery tasks to a self-assignment system; and
receiving one or more delivery offers from the self-assignment system;
the self-assignment system, comprising:
one or more memory devices storing instructions; and
one or more processors configured to execute the instructions to perform operations comprising:
receiving, from a first mobile device of the system and in response to at least one selection made on a user interface element of the first mobile device, the request, an available time frame for the one or more delivery tasks, and a geographical area for the one or more delivery tasks;
accessing a first database storing delivery tasks;
determining which of the stored delivery tasks needing assignment have a delivery route in the received geographical area;
determining one or more delivery offers by filtering the determined delivery tasks within the received available time frame, each delivery offer associated with a status of fully assigned, partially assigned, or not assigned, the status being based on a comparison of:
a number of workers assigned to the task, and
a number of workers necessary to complete the task;
selecting, from among the determined delivery offers, one or more delivery offers having a status equal to partially assigned or not assigned;
transmitting the one or more selected delivery offers to the first mobile device;
receiving, from the first mobile device, an acceptance of at least one of the transmitted delivery offers;
based on the received acceptance, adjusting the status of the at least one accepted delivery offer;
providing, for presentation via the first mobile device, a user interface that includes a confirmation of the at least one accepted delivery offer and a link to a communication channel for communication between the first mobile device and a remote device;
storing the adjusted status of the accepted delivery offer in a second database;
receiving a second request for one or more delivery tasks from a second mobile device; and
responding to the received second request by transmitting one or more selected delivery offers based on the adjusted status.

20. The system of claim 19, further comprising:
wherein the instructions of the first mobile device further cause the processors of the first mobile device to perform operations comprising:
transmitting acceptance of the one or more received delivery offers;
receiving data input at a first user interface from the self-assignment system;
composing a second user interface including a schedule; and
displaying the second user interface including the schedule; and
wherein the instructions of the self-assignment system further cause the processors of the self-assignment system to perform operations comprising:
receiving, from the first mobile device, the acceptance of one or more delivery offers;
increasing the number of delivery workers assigned to the accepted delivery offers by one;
adjusting the status of the accepted delivery offers to fully assigned, if the increased number of delivery workers assigned to the accepted delivery offers equals the number of delivery workers required to complete offer, or partially assigned, if the increased number of delivery workers assigned to the accepted offers is less than the number of delivery workers required to complete offer;
storing the adjusted status of the accepted delivery offers in the database; and
providing, for presentation via the first mobile device, a third user interface that includes a confirmation of accepted delivery offers and a link to a communication channel for further communication with the first mobile device.
